(19) United States
(12) Patent Application Publication
(10) Pub. No.: US 2025/0031168 A1
(43) Pub. Date: Jan. 23, 2025

(54) ELECTRONIC DISPLAY DEVICE WITH AN ACCELERATION SENSOR

(71) Applicant: PDI DIGITAL GMBH, Fernitz-Mellach (AT)

(72) Inventor: Markus RUMPF, Fernitz-Mellach (AT)

(73) Assignee: PDI DIGITAL GMBH, Fernitz-Mellach (AT)

(21) Appl. No.: 18/708,696

(22) PCT Filed: Dec. 23, 2021
(86) PCT No.: PCT/EP2021/087569

§ 371 Date: May 9, 2024

(51) Int. Cl. H04W 60/04; H04W 64/00

(52) U.S. Cl. CPC H04W 60/04; H04W 64/006

(57) ABSTRACT

Electronic display device (7),
which comprises a display module (8) for the visualisation of price and/or product information, which can be received in the course of radio communication with an access point (3A-3D), and
which comprises an acceleration sensor (10), which is designed to detect an acceleration of the display device (7), and to provide a detection signal (ED) representing the detected acceleration, and
which comprises a communication module (9), which is designed for radio communication with a previously established first access point (3A), characterised in that,
the communication module (9) is designed to identify the occurrence of at least two mutually distinguishable patterns over the time profile of the detection signal (ED) provided, and, depending on the pattern identified, either to verify the communication availability of the previously established first access point (3A) for further radio communication, or to determine a second access point (3B) for further radio communication.

### TECHNICAL FIELD

The invention relates to an electronic display device with an acceleration sensor.

### BACKGROUND

A battery-operated electronic display device, in the form of a display panel with an acceleration sensor, is of known art, for example, from the published patent application WO 2020/193705 A1. On the display panel, the acceleration sensor is used to detect a movement of the display panel, so that GPS data, which can subsequently be transmitted by radio from the display panel, is only retrieved as a result of the movement being detected, which saves energy. However, the display panel also comprises a control unit and a temperature sensor, wherein the control unit can activate or deactivate a receiver module or a radio module depending on signals from the temperature sensor, wherein, depending on the ambient temperature, the communication availability of the display panel is influenced such that the communication availability is only provided within a permissible temperature range in order to impede or avoid further unnecessary energy consumption.

This combination of features of known art has proved its worth in avoiding energy wastage in a battery-operated display device. However, this combination of features can only be used in the very specific field of application as is disclosed in WO 2020/193705 A1.

The invention has therefore set itself the object of creating an improved display device, which in particular can also be used inside buildings, particularly preferably in the goods logistics sector.

### SUMMARY OF THE INVENTION

This object is achieved by means of a display device in accordance with claim 1. The subject matter of the invention is therefore an electronic display device, abbreviated to display device, which comprises a display module for the visualisation of price and/or product information, which can be received in the course of radio communication with an access point, and which comprises an acceleration sensor, which is designed to detect an acceleration of the display device, and to provide a detection signal representing the detected acceleration, and which comprises a communication module, which is designed for radio communication with a previously established first access point, characterised in that, the communication module is designed to detect the occurrence of at least two mutually distinguishable patterns in the time profile of the detection signal provided, and, depending on the pattern identified, either to verify a communication availability of the previously established first access point for further radio communication, or to define a second access point for further radio communication.

This object is further achieved by an operating method in accordance with claim 9. The invention therefore relates to an operating method for the operation of an electronic display device, wherein, in accordance with the operating method, price and/or product information, received in the course of radio communication of a communication module of the display device with a previously established access point, is displayed with a display module of the display device, and an acceleration of the display device is detected with an acceleration sensor of the display device, and a detection signal representing the detected acceleration is provided, characterised in that, the communication module processes the detection signal of the acceleration sensor, such that a pattern identification is executed for the detection of two mutually distinguishable patterns in the time profile of the detection signal, and in that the communication module, depending on the pattern identified, either verifies the communication availability of the previously established first access point for further radio communication, or determines a second access point for further radio communication.

The advantage of the inventive measures is that the electronic display device can automatically check whether a movement to which it is subjected makes it necessary to change the access point to be used for further radio communication, or to continue using the access point currently provided for this purpose. This ensures an optimum communication availability for the display device, despite movement of the display device, which is particularly advantageous when implementing a system indoors in a building with a large number of access points.

It is therefore no longer necessary, as with conventional electronic display devices, to wait until the communication module detects that the connection to the first access point has been lost, before initiating a new connection with another access point. In accordance with the invention, the continuous communication availability is also ensured, in particular because there is no need to run through a sequence of disconnection, which must first be identified by the display device, and then a re-establishment of the connection. On the one hand, such a sequence is disadvantageously associated with a considerable energy requirement, and, on the other hand, would mean that the display device would be offline for its supply of data from one of the access points, at least during a period of time from the detection of the connection failure to the completion of the re-establishment of the connection. From the perspective of the access point, however, this offline state can last even longer, because the disconnection must be detected by the display device before the latter initiates a reconnection. In a conventional system for electronic display devices, a high degree of uncertainty can therefore occur with regard to the communication availability of the display devices; this uncertainty is avoided by the present invention because, based on the pattern of the acceleration profile to which the display device is exposed, a timely roaming function is triggered and executed as soon as a switch of access point appears to be necessary.

Further, particularly advantageous, configurations and developments of the invention ensue from the dependent claims together with the following description. It should be mentioned here that the advantages and actions mentioned in the context of the display device also occur analogously in the context of the corresponding method features.

The invention discussed here is primarily used in the context of an ESL system. In such a system, a multiplicity of such electronic display devices, that is to say, ESLs, exists, in order to visualise price and/or product information for a product or a product group.

Such ESLs can be attached to shelves, or the rails of the shelves, or directly to the products, or their packaging. An attachment structure, on which the ESLs and the product are located, can be designed as a shelf, or as a shelf level. Attachment to a presentation table is also possible. Such ESLs can also be designed as a display panel for placement on a table. Such a display device can also be designed as a tag for attachment to an item of clothing. The attachment structure can therefore also be designed as a connecting link between the electronic display device and the product. Such an attachment structure can also be implemented, for example, in the form of a stitching thread, a needle, or similar. If larger packaging units of products are labelled with the aid of an ESL, the ESL can also be attached to the structure carrying the packaging units, such as a pallet, etc., or to the packaging that encloses the large number of products packaged with the latter.

For purposes of visualising information, each ESL comprises a screen, which is usually implemented in the form of an electrophoretic screen in order to enable the most energy-efficient operation possible in the case of battery-operated ESLs. However, other types of screens, such as LCD screens or similar, can also be used. Electrical energy can also be supplied by means of radio signals, which is known in the technical jargon as “power over WIFI”, wherein the energy transmitted in this way is stored in an electrical energy storage device, such as a rechargeable battery of the ESL.

In a radio-based ESL system, there are also a large number of access points that form a radio network for the communication supply of the ESLs, in order to send data addressed to the ESLs, or to retrieve data addressed from the ESLs. A group of ESLs is usually assigned in each case to an access point, and can be addressed via this access point. The assignment works by selecting a suitable radio channel in the ISM radio band (here ISM stands for “industrial, scientific and medical”), which is used by the respective access point, and in registration of the ESL in question with the access point responsible for the latter. Here the ESL memorises the channel and the identity of the access point, and the access point memorises the identity of the ESL. The ESL registered in this way can therefore subsequently execute radio communication with the previously established access point. If the connection with the previously established access point is lost, the ESL can search for another radio access point, wherein the available channels (known to the ESL, or programmed in advance) are scanned and, if an access point or its radio signal is identified (e.g. based on the SSID—where SSID stands for “service set identifier”), a new registration is executed with this access point.

Neighbouring access points that are distributed throughout the premises of a retailer or a warehouse, such that they can detect all the ESLs positioned there, prefer to use radio channels in the ISM band that as far as possible do not overlap, so as not to interfere with each other.

An essentially standardised radio communication protocol, such as ZigBee® or Bluetooth®, can be used for the radio communication between the ESLs and the access points that in each case are responsible for the latter. A proprietary radio communication protocol, such as that disclosed in WO 2015/124197 A1, can also be used.

For their part, the access points are typically connected by cable to a central control device, such as a local server, on which a software application (such as shop management software) for managing and controlling the ESLs is executed, or they can also be controlled via a cloud-based software application that provides the above-mentioned functionality for managing and controlling the ESLs. With the aid of the access points, this central control device supplies the individual ESLs with the price and/or product information assigned to them and, if necessary, can also query the operating status, or other status data, of the ESLs, and can react to the latter.

The invention, as discussed, can be used in all areas of application in which the infrastructure of access points, as discussed, supplies a large number of ESLs with radio technology and, by virtue of the fact that the individual ESLs are moved, it may be necessary to change the radio technology for the ESL concerned from a previously established access point to another access point.

In accordance with a first form of the invention, the electronic display device or its communication module is designed to identify a first pattern in the time profile of the detection signal, which first pattern indicates a movement of the display device that leaves the display device within a radio communication range of the first access point. Such a movement is usually characterised by only relatively short accelerations, possibly also with low acceleration values, which occur, for example, when the product to which the display device is attached is briefly lifted by a person or a machine, possibly moved only slightly on a shelf, and placed back on the same shelf. The acceleration time profiles that typically occur in this process can be determined experimentally in advance and parameterised, for example, with regard to the intensity, and/or frequency, and/or duration, parameters. Thus, a range from low to violent accelerations, coupled with a relatively short duration in which these accelerations occur, can be characteristic of this first type of movement.

If such a first type of movement is suspected by the detection of the first pattern, it is advantageous that the communication module first verifies the communication availability of the previously established first access point for further radio communication. For purposes of verifying the communication availability of the first access point, the communication module is designed to check received radio signals to see whether these received radio signals can be assigned to the first access point. The received radio signals are therefore used to check whether the access point previously established is still available by radio. If the radio availability is verified, there is no reason to switch to another access point.

However, it can also be advantageous if not only the information content of the received radio signals is checked. For a more precise verification of communication availability, it may also be envisaged that the communication module is designed to take into account a signal parameter that can be derived from the received radio signal. This signal parameter can be, for example, the signal strength, or the field strength of the received radio signal, which radio signal is assigned to the previously established access point in terms of content. The RSSI (where RSSI stands for “received signal strength indicator”) of the received radio signal, which is determined in the communication module, can also be taken into account. All of these signal parameters can be used—in particular if they are related to a threshold value—as an indication that the existing communication availability is sufficiently good to maintain the previously established first access point for further radio communication.

In accordance with a second form of the invention, the display device, that is to say, its communication module, is designed to identify a second pattern in the time profile of the detection signal, which second pattern indicates a movement of the display device that removes the display device from the radio communication range of the first access point. Such a movement is usually characterised by more intensive, possibly also longer-lasting, acceleration profiles compared to the first type of movement and/or a sequence of, possibly only slight to moderate, accelerations occurring over a relatively long time interval. Such a time profile of acceleration occurs, for example, during manual or mechanical carrying, when the product to which the display device is attached is moved by a person or a machine to another location in the shop or warehouse. This results in a longer persisting initial acceleration compared to the first type of movement; this usually occurs after the first type of movement and occurs when a person or a forklift truck, etc. starts to move. Subsequently, during continuous movement, which usually takes place at a relatively constant speed, typical oscillating movements occur, which can be attributed to vibrations or swaying in the course of mechanical movement, or to the typical alternating up and down movements that occur when a person is walking. The time profiles of acceleration that typically occur can be determined experimentally in advance and parameterised, for example, with regard to the intensity, and/or frequency, and/or duration, parameters. Thus, for example, a relatively intensive acceleration phase that initiates the movement, coupled with subsequent, longer-lasting acceleration sequences that are typical of the swaying or alternating movement, can be characteristic of this second type of movement.

If such a second type of movement is detected, it is advantageous that the communication module is designed to receive radio signals for purposes of determining the second access point, and to analyse them to determine whether they can be assigned to an access point other than the first access point. Here the communication module is primarily operated in receive mode, and the received radio signals are checked to see whether they indicate the existence of an access point in the relevant channels; this can be determined, for example, by receiving a radio signal characteristic of the access points being used or its information content (e.g. the SSID matching the radio network of the ESLs—where SSID stands for “service set identifier”—also known as the network name).

This initiates the switch to an access point other than the one (previously) established. For this purpose, the communication module is designed to execute a registration with the access point other than the second access point, when radio signals that can be assigned to an access point other than the first access point are detected. Here the communication module can also remain in receive and analyse mode for a longer period of time until the opportunity arises (e.g. as indicated by the signal parameters of the received radio signal) to switch reliably to the second access point. The previously mentioned signal parameters can also be used here to check a criterion for changing the access point in relation to a threshold value. If the selected signal parameter or a combination of the signal parameters indicates that the change is favourable because, for example, the signal strength of the first access point has fallen below a threshold value, while the signal strength of a potential second access point increases during the movement of the display device, the communication module terminates the connection with the first access point and executes the registration at the second access point. This ensures that communication is always available for the display device in question.

In principle, the ESLs can therefore determine at any point during its movement sequence that the second pattern has occurred in the acceleration profile, and can endeavour to switch to a second access point, and, if the technical radio conditions permit, can also put this into effect. If it is not immediately possible to switch from the first access point to the second access point, due to the current radio signal supply situation, the ESL repeats the reconnection attempt after a waiting time has elapsed, or attempts to reconnect almost continuously as the movement continues. In so doing, it maintains its assignment to the first access point, provided the radio signal supply allows this.

It should also be mentioned that it can also be fundamentally irrelevant whether the ESL is always travelling in a spatial region during its movement in which there is sufficient radio signal coverage for its radio communication at all times. On the contrary, the ESL can also be moved through so-called dead spots on its route where there is insufficient radio signal coverage. In this situation, the need to change the access point determined by the pattern identification can simply remain pending until radio signal coverage is once again available.

Situations can also arise in which the second pattern is determined from the movement sequence during the entire path, or only during a section of the path. For example, the profile of the acceleration values that is decisive for pattern identification may only be completed towards the end of the route. For example, the ESL may have already passed the dead zone, that is to say, it may have left the communication range of the first access point, and may only then identify the second pattern and establish a connection with the second access point, into whose communication range it has already entered as a result of leaving the dead zone. Logging off from the first access point is no longer possible in this situation and is also no longer envisaged. Instead, the information that the ESL is no longer assigned to the first access point can be communicated to the first access point via the server.

In accordance with a further aspect, the invention can also be used in an ESL system in which the display device predominantly remains in an energy-saving idle state and only temporarily switches to an active state, for example in order to check its synchronism with the associated access point, and/or to execute radio communication with the access point. In order to ensure the fastest possible reaction to a change in position, even with such a design of the display device, which comprises an active state, with availability of the communication module for radio communication, and an energy-saving idle state, without availability of the communication module for radio communication, it has proved to be particularly advantageous if the display device or its communication module is designed to leave the idle state and switch to the active state when triggered by the acceleration sensor. The occurrence of the detection signal, or the reception of an interrupt signal emitted by the acceleration sensor to the communication module, acts as a trigger signal for the execution of the pattern identification in the time profile of the detection signal, after which the decision can be made, depending on the identified pattern, as to whether the currently selected access point should continue to be used for further radio communication, or whether to switch to another, namely the second access point. The invention is thus also available for an energy-efficient battery-operated ESL system, which is operated with a highly energy-efficient time slot communication method, of known art, in particular from WO 2015/124197 A1, to decide autonomously whether to initiate a relatively high power-consuming roaming function for switching to another access point, during which roaming function data must also be actively transmitted. Often, however, particularly when the first pattern is identified, it will be sufficient for the communication module to leave the idle state, but only receive the available radio signals in a relatively low-power receiving state (that is to say, without actively transmitting data) in order to verify the communication availability of the first access point.

In summary, it should therefore be noted that, in the embodiments of the display device discussed, it is possible to determine, in the most battery-saving manner possible, whether it is necessary to switch to another access point, or whether it is more favourable to remain with the access point currently provided, for further radio communication.

Furthermore, the invention can also be used to prevent theft. Here, for example, a theft alarm can be triggered simply by the fact that the object to which the display device is attached is moving, that is to say, a correspondingly parameterised or specified acceleration can be detected. The change from the first access point to the second access point, which is identified as necessary on the basis of the pattern identified, can also be used as a trigger for the theft alarm.

It should also be mentioned that the acceleration sensor can be designed to provide uni-axial or multi-axial detection results. Further processing of the detection result can therefore take place on the basis of a scalar, such as the magnitude of a vector in the case of multi-axial detection results, or also taking into account the direction of the detected acceleration, which can also be included in the check for the presence of one of the two previously mentioned patterns. If necessary, the patterns can be refined and defined more precisely by taking the direction of acceleration into account.

Finally, it should be mentioned in general that the electronic devices discussed (ESLs, access points, servers, etc.) or their stages or modules, needless to say, incorporate electronics. The electronics can be discrete or integrated electronics, or a combination of both. Micro-computers, micro-controllers, application specific integrated circuits (ASICs) can also be used, possibly in combination with analogue electronics or digital electronic peripheral components. Many of the mentioned functionalities of the devices are implemented—where appropriate operating together with hardware components—with the aid of software that is executed on a processor of the electronics. Devices designed for radio communication usually comprise an antenna configuration, possibly also a matching network etc., as part of a transceiver module for transmitting and receiving radio signals, and can be controlled with digital signals, or can emit digital signals. Apart from the ESLs, the electronic devices can also comprise an internal electrical power supply, which can be implemented in the form of a replaceable or rechargeable battery, for example. The devices can also be supplied via a wired connection, either by an external power supply unit, or also by means of “power over LAN”.

These and other aspects of the invention are illustrated by the figures discussed below.

### BRIEF DESCRIPTION OF THE FIGURES

The invention is explained in more detail below with reference to the attached figures using examples of embodiment, to which, however, the invention is not limited. In the various figures, identical components are here labelled with identical reference symbols. In a schematic manner:

FIG. 1 shows an electronic display system installed in a warehouse, with an electronic display attached to a product, and two exemplary alterations in position of the display device within the warehouse;

FIG. 2 shows a block diagram of the electronic display device, comprising an acceleration sensor;

FIG. 3 shows detection signals of the acceleration sensor resulting from the first alteration in position;

FIG. 4 shows detection signals of the acceleration sensor resulting from the second alteration in position.

### DESCRIPTION OF THE EXAMPLES OF EMBODIMENT

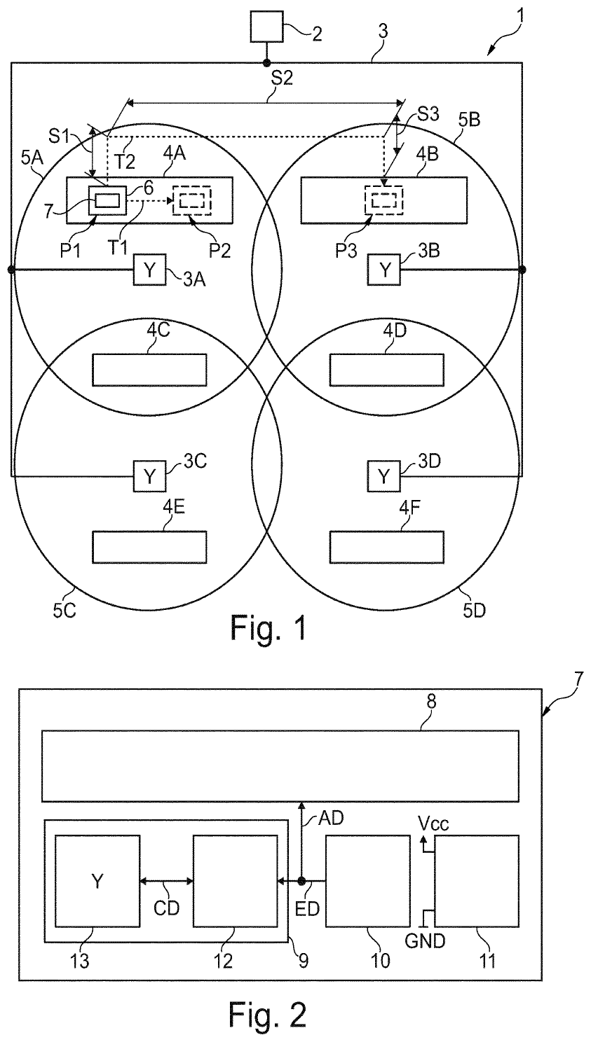

FIG. 1 shows an ESL system 1, hereinafter referred to for short as system 1, which is installed in a warehouse. System 1 comprises a server 2, which is connected to four access points 3A-3D via a wired LAN 3 (where LAN stands for “local area network”). The LAN 3 and the access points 3A-3D form the communication infrastructure for communicating by radio with battery-operated electronic display devices (abbreviated as ESL for “electronic shelf label”), wherein the ESLs are attached to products in the warehouse, and wherein the products are stored on shelves 4A to 4F. The shelves 4A-4F and the access points 3A-3F are arranged in the warehouse such that the shelves 4A-4F are arranged within the radio coverage regions 5A-5D of the access points 3A-3F, and consequently the ESLs located on them are reliably available by radio for radio communication with the respective access point 3A to 3D, to which they are assigned by radio by prior registration. The total radio range coverage of all the access points 3A-3D also covers the majority of the warehouse, that is to say, also the regions between the shelves, although it is quite possible for there to be radio gaps.

In order to simplify the discussion, only one single product 6, which is stored in the shelf 4A, and to which the ESL 7 is attached, is discussed below. The functionality discussed here can of course be implemented for any number of ESLs 7. The ESL 7 is discussed in more detail below with the aid of FIG. 2.

The ESL 7 comprises a display module 8, which, as an external manifestation of the ESL, comprises an electrophoretic screen (not shown) for the display of price and/or product information, hereinafter referred to as the information for short, in the most energy-efficient manner possible. In addition to the screen, the display module 8 comprises a display module control stage (not shown), which provides the usual functionalities of such a display module 8 for purposes of operating the screen.

The information in question is transmitted from the server 2 via the communication infrastructure, specifically via the first access point 3A, to the ESL 7, which comprises a communication module 9 for the receipt of this information, which is represented by communication data CD. The communication module 9 is functionally divided into a transceiver 13 and a control stage 12. The transceiver 13 is designed for radio communication with the access points 3A-3D, that is to say, as an interface between radio signals and internal digital signals, and communicates the communication data CD to the control stage 12. The control stage 12 is designed for the digital data processing required in the ESL 7, and the control of the functions of the ESL 7, in particular the control of the display module 8 via an internal data bus, which connects the communication module 9 with the display module 8, and the control of the radio traffic in accordance with a radio communication protocol that is to be used. It should be mentioned here that the transceiver 12 can also comprise its own intelligent transceiver control stage (not shown) in order to process the radio communication in accordance with the radio communication protocol mentioned.

The ESL 7 is supplied electrically from a battery 11, which provides a supply voltage VCC with respect to a reference potential GND for all the electronic components of the ESL 7.

The ESL 7 also comprises an acceleration sensor 10, which detects an acceleration of the ESL 7, and transmits an electronic detection signal, in this case represented as detection data ED, to the control stage 12.

An acceleration of the ESL 7 always occurs when the ESL 7 is moved; this is visualised in FIG. 1 by two exemplary movement paths T1 and T2, which are referred to below in brief as paths T1 and T2.

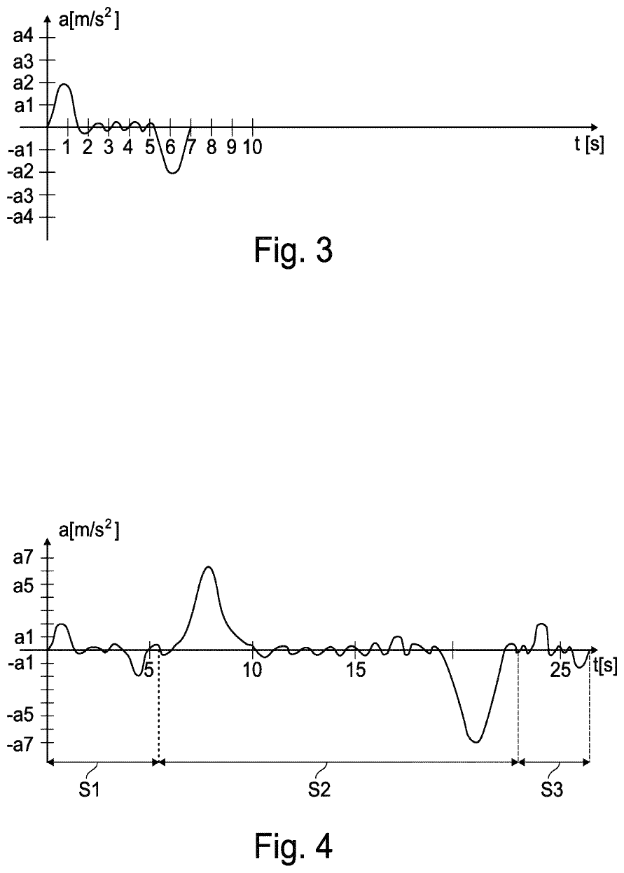

In the case of the first path T1, it is assumed that the product 6 is merely moved—e.g. manually—in the first shelf 4A from its starting position P1 into a first end position P2 within the first shelf 4A. The acceleration profile occurring over time is illustrated with the aid of a first diagram shown in FIG. 3. Here, the acceleration a, which is usually specified in the unit m/s², is plotted against the time t, wherein the time scale t is scaled in seconds and the acceleration scale a is scaled with symbolic values from −a4 to +a4. The movement of the product 6 on which the first diagram is based begins at time t=0 seconds and ends at time t=7 seconds. In the course of this movement, a relatively moderate acceleration up to the value +a2 m/s² takes place over a period of just under 2 seconds, so as to set the product in motion. The product is then moved towards the end position P2 at an approximately constant speed for a period of approximately 3 to 4 seconds until, towards the end of path T2, the speed is reduced to a standstill during a period of just under 2 seconds by a braking process, with acceleration values of up to −a2 m/s² occurring during this deceleration phase. While the product 6 is moved at an approximately constant speed, only slight fluctuations in the acceleration occur, which is visualised in the acceleration over time between the dominant acceleration maxima of +a2 m/s² and −a2 m/s² by a slight fluctuation in the acceleration values a along the time axis around the zero point of the acceleration.

In the case of the second path T2, it is assumed that the product 6 is removed from the first shelf 4A with the aid of an automatic forklift truck (not shown) and transported to the second shelf 4B with the aid of the automatic forklift truck. The second path T2 also begins at the starting position P1, but ends in a second end position P3, which is located in the second shelf 4B. The second path T2 can be divided into three path sections, namely a first path section S1, a second path section S2, and a third path section S3. The time profile of the acceleration occurring along the second path T2 is illustrated with the aid of a second diagram shown in FIG. 4, wherein the corresponding path sections S1 to S3 are entered here along the time axis t.

Along the first path section S1, the product 6 is lifted out of the first shelf 4A rather slowly and carefully. Along the third path section S3, the product 6 is also placed into the second shelf 4B rather slowly and carefully. The two path sections S1 and S3 are very similar in terms of the movement sequence and consequently also in terms of the acceleration profile. In these path sections S1 and S3, a movement takes place with an acceleration profile over time that is similar to that of the first diagram in FIG. 3 in terms of its duration and the acceleration values that occur.

In the course of the movement between the path sections S1 and S3, that is to say, along the second path section S2, the acceleration over time differs significantly from that of the path sections S1 and S2. This is because there is initially a relatively strong acceleration during a time span of approx. 3 seconds up to a value of approx. +a7 m/s², in order to set the product 6 in motion. The product 6 is then moved towards the third path section S3 at an approximately constant speed, which in the present case is high enough to ensure that the second path section S2 to the second shelf 4B is completed as quickly as possible, that is to say, in a time-saving manner, until the speed is reduced to a standstill by a braking process towards the end of the second path section S2, with acceleration values of up to a value of approximately −a7 m/s² occurring during this deceleration phase. While the product 6 is moved at an approximately constant speed, only slight fluctuations in the acceleration occur, which is visualised in the acceleration over time between the dominant acceleration maxima of +a7 m/s² and −a7 m/s² by a slight fluctuation in the acceleration values along the time axis t around the zero point of the acceleration.

As already mentioned, the acceleration detected by the acceleration sensor 10 during the movement of the ESL 7 is transmitted to the communication module 9 with the aid of the acceleration data ED, and is received there by the control stage 12, and is buffered at least temporarily for a duration sufficient for pattern identification, and the time profile of the acceleration values is analysed with regard to the occurrence of a first pattern, or a second pattern that can be distinguished from the first pattern.

In the present case, the first pattern is defined such that it is similar to that of the first diagram, or at least has its characteristic properties. The acceleration profile is therefore checked to ensure that only moderate acceleration maxima (here up to a maximum of +/−a3 m/s²) occur during a relatively short time interval (here typically a few seconds, e.g. a maximum of approx. 10 seconds in the present case), between which there are some oscillations around the zero line. Such a pattern suggests that the ESL 7 is only subject to minor movements in the time interval under consideration, such as a movement only within the first shelf 4A, or that it was only lifted briefly and then put down again. Such a first pattern allows the conclusion with a high degree of probability that the ESL 6 has not left the radio communication range 5A of the first access point 3A, with which it is already registered, and which is therefore envisaged for further radio communication. To check this, the communication module 9 (controlled by the control stage 12) enters into a receive mode when the first pattern is identified, and verifies that it is still receiving radio signals (with sufficient signal quality) from the first access point 3A. If this is the case, the verification of communication availability is complete. If this is not the case, a connection is established to one of the other access points 3B-3D in order to ensure a continuing communication availability in system 1.

In the present case, the second pattern is defined such that it is similar to that of the second diagram, in particular to that part of the second diagram corresponding to the second path section T2, or at least has its characteristic properties. The acceleration profile is therefore checked to ensure that during a relatively long time interval (here, for example, one of more than ten seconds) conspicuously high acceleration maxima (here, for example, over a maximum of +/−a4 m/s²) occur, between which a large number of oscillations around the zero line occur over a relatively long period of time. Such a pattern suggests that the ESL 7 has been subjected to a large movement and an associated displacement, such as a displacement from the first shelf 4A to the second shelf 4B. Such a second pattern makes it highly likely that the ESL 6 has left the radio range of the first access point 3A, with which it is already registered and which is therefore intended for further radio communication, or that the location of the ESL 7 has been moved so far that another access point would be preferable for further radio communication. In order to ensure the continued availability of communication in system 1, when the second pattern is identified, the first ESL 7 establishes a connection with another access point, in this case the second access point 3B in whose radio coverage region 5B it has been placed, and once registration with the second access point 3B has been completed, the latter is designated for further radio communication.

In accordance with a further form of embodiment, the acceleration sensor 10 may also be a component of the communication module 9. In particular, the blocks 13, 12 and 10 can be present in a “system-on-a-chip” implementation. Furthermore, it is also possible for the acceleration sensor 10 to control directly the transceiver 13 with its detection signal, if the latter is designed to receive and process the detection signal (e.g. it has its own processor for providing the entire communication functionality, including a roaming function for the access points 3A-3D). In this case, the functionality of the control stage 12 is limited to all other components to be controlled within the display device 7.

The measures discussed thus ensure that the radio communication availability on the part of the ESL 6 affected by a movement is ensured on an event-related basis, that is to say, by identifying the respective pattern in the acceleration data, that is to say, the assignment to a predefined access point is maintained, or a change to another access point is executed.

Although the present discussion of the invention has only dealt with a relatively simple movement of the ESL 7 within a shelf 4A, or between two immediately neighbouring shelves 4A and 4B, it should be mentioned at this point that the invention can of course also be applied to more complex movement sequences.

Finally, it should also be emphasised that the invention is ideally suited for use in highly, or fully, automated warehouses, because the mechanical, automated product movement in such warehouses means that the expected movement sequences and the associated acceleration profiles can be well predicted, in particular with high precision. As a result, the two patterns can be clearly differentiated from one another. Against this background, a plurality of subsidiary patterns can also be stored for each pattern; these can be thematically summarised on the basis of the previously known movements that are to be implemented by machine.

Finally, it is pointed out once again that the figures described in detail above are only examples of embodiment; these can be modified by the person skilled in the art in various ways without leaving the scope of the invention. For the sake of completeness, it is also pointed out that the use of 10 the indefinite articles “a” or “one” does not exclude the possibility that the features in question may also be present more than once.

1. Electronic display device (7),
which comprises a display module (8) for the visualisation of price and/or product information, which can be received in the course of radio communication with an access point (3A-3D), and
which comprises an acceleration sensor (10), which is designed to detect an acceleration of the display device (7), and to provide a detection signal (ED) representing the detected acceleration, and
which comprises a communication module (9), which is designed for radio communication with a previously established first access point (3A), characterised in that,
the communication module (9) is designed so as to identify an occurrence of at least two mutually distinguishable patterns in the time profile of the detection signal (ED) provided, and, depending on the pattern identified, either to verify a communication availability of the previously established first access point (3A) for further radio communication, or to determine a second access point (3B) for further radio communication.

2. Electronic display device (7) in accordance with claim 1, wherein the communication module (9) is designed so as to identify a first pattern in the time profile of the detection signal (ED), which first pattern indicates a movement of the display device (7) that leaves the display device (7) within a radio communication range (5A) of the first access point (3A).

3. Electronic display device (7) in accordance with claim 1, wherein, for purposes of verifying the communication availability of the first access point (3A), the communication module (9) is designed to check received radio signals, as to whether these received radio signals can be assigned to the first access point (3A).

4. Electronic display device (3A) in accordance with claim 3, wherein, for purposes of verifying the communication availability of the first access point (3A), the communication module (9) is designed to take into account a signal parameter that can be derived from the received radio signal.

5. Electronic display device (7) in accordance with claim 1, wherein the communication module (9) is designed to identify a second pattern in the time profile of the detection signal (ED), which second pattern indicates a movement of the display device (7) that removes the display device (7) from a radio communication range (5A) of the first access point (3A).

6. Electronic display device (7) in accordance with claim 5, wherein, for purposes of determining the second access point (3B), the communication module (9) is designed to receive radio signals, and to analyse them in order to determine whether they can be assigned to an access point other than the first access point (3A).

7. Electronic display device (7) in accordance with claim 6, wherein, in the course of detecting radio signals that can be assigned to an access point other than the first access point (3A), the communication module (9) is designed so as to execute a registration of the other access point as the second access point (3B).

8. Electronic display device (7) in accordance with claim 1, wherein the display device (7) comprises:
an active state, with availability of the communication module (9) for purposes of radio communication, and an energy-saving idle state, without availability of the communication module (9) for purposes of radio communication,
wherein
the communication module (9) is designed so as to be caused by the acceleration sensor (10) to leave the idle state and switch to the active state.

9. Operating method for the operation of an electronic display device (7), wherein, in accordance with the operating method,
price and/or product information, received in the course of radio communication of a communication module (9) of the display device (7) with a previously established access point (3A), is displayed with a display module (8) of the display device (7), and
an acceleration of the display device (7) is detected with an acceleration sensor (10) of the display device (7), and a detection signal (ED) representing the detected
acceleration is provided,
characterised in that
the communication module (9) processes the detection signal (ED) of the acceleration sensor (10), such that a pattern identification process is executed so as to identify two mutually distinguishable patterns in the time profile of the detection signal (ED), and in that the communication module (9), depending on the pattern identified, either verifies the communication availability of the previously established first access point (3A) for further radio communication, or defines a second access point (3B) for further radio communication.

10. Operating method (7) in accordance with claim 9, wherein, in the course of executing the pattern identification process, a check is made for the presence of a first pattern in the time profile of the detection signal (ED), which first pattern indicates a movement of the display device (7) that leaves the display device (7) within a radio communication range (5A) of the first access point (3A).

11. Operating method in accordance with claim 9, wherein, in the course of executing the pattern identification process, the communication module (9) is designed to identify a second pattern in the time profile of the detection signal (ED), which second pattern indicates a movement of the display device (7) that removes the display device (7) from a radio communication range (5A) of the first access point (3A).

12. Operating method in accordance with Claim 9, wherein the display device (7) is operated alternately in an active state, with availability of the communication module (9) for radio communication, and in an energy-saving idle state, without availability of the communication module (9) for radio communication, wherein in the idle state the detection signal (ED) is received by the communication module (9), and a change from the idle state to the active state takes place on the communication module (9) as a consequence of the reception of the detection signal (ED).
